(19) United States
(12) Patent Application Publication
(10) Pub. No.: US 2026/0029736 A1
(43) Pub. Date: Jan. 29, 2026

(54) HEATING DEVICE AND IMAGE FORMING APPARATUS

(71) Applicant: FUJIFILM Business Innovation Corp., Tokyo (JP)

(72) Inventors: Hina SAITO, Kanagawa (JP); Takashi MATSUBARA, Kanagawa (JP); Takashi OHASHI, Kanagawa (JP); Takuma ISHIHARA, Kanagawa (JP); Motoharu NAKAO, Kanagawa (JP)

(73) Assignee: FUJIFILM Business Innovation Corp., Tokyo (JP)

(21) Appl. No.: 19/045,527

(22) Filed: Feb. 4, 2025

(30) Foreign Application Priority Data
Jul. 24, 2024 (JP) 2024-118366

(51) Int. Cl. G03G 15/20

(52) U.S. Cl. CPC G03G 15/2057; G03G 15/2064; G03G 2215/2019; G03G 2215/2025

(57) ABSTRACT

A heating device includes a heating roller that is rotated to heat a member to be heated, in which the heating roller is provided with at least an electrically insulating layer and a resistance heat generating layer that are provided in this order on one or both of an inner peripheral surface and an outer peripheral surface of a cylindrical roller substrate made of metal on which rust occurs, without an anti-rust layer.

### CROSS-REFERENCE TO RELATED APPLICATIONS

This application is based on and claims priority under 35 USC 119 from Japanese Patent Application No. 2024-118366 filed Jul. 24, 2024.

### BACKGROUND

### (i) Technical Field

The present invention relates to a heating device and an image forming apparatus.

### (ii) Related Art

JP2001-134124A (claim 1, Paragraph 0006, and FIG. 1) discloses a heat-generating fixing roller that includes a cylindrical metal core, an insulating layer laminated inside the metal core, and a heat generating element laminated on the insulating layer.

Further, JP2001-134124A (claim 1, Paragraph 0006, and FIG. 1) discloses that a metal foil pipe having a thermal expansion coefficient higher than the thermal expansion coefficient of the metal core is inserted into an inner surface of the heat generating element via another insulating layer.

Furthermore, for example, JP2001-134124A (claim 1, Paragraph 0006, and FIG. 1) describes that the above-mentioned metal core needs to be preferably subjected to, for example, Parker treatment for preventing the rust of iron or the like.

### SUMMARY

Aspects of non-limiting embodiments of the present disclosure relate to a heating device that can prevent the peeling of a resistance heat generating layer or the like at a portion where a rapid temperature change occurs during heating on a heating roller in which at least an electrically insulating layer and the resistance heat generating layer are provided in this order on one or both of an inner peripheral surface and an outer peripheral surface of a cylindrical roller substrate made of metal on which rust may occur, without adding a new member, and an image forming apparatus using the heating device.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a heating device including a heating roller that is rotated to heat a member to be heated, and the heating roller is provided with at least an electrically insulating layer and a resistance heat generating layer that are provided in this order on one or both of an inner peripheral surface and an outer peripheral surface of a cylindrical roller substrate made of metal on which rust occurs, without an anti-rust layer.

### BRIEF DESCRIPTION OF THE DRAWINGS

Exemplary embodiment(s) of the present invention will be described in detail based on the following figures, wherein:

FIG. 1 is a schematic view of an image forming apparatus according to a first exemplary embodiment of the present invention;

FIG. 2 is a schematic view of a fixing device that is an example of a heating device according to the first exemplary embodiment;

FIG. 3 is a schematic view showing a heating roller and the like, which are a part of the fixing device shown in FIG. 2, in a partial cross section;

FIG. 4A is a schematic cross-sectional view of the heating roller shown in FIG. 2, and FIG. 4B is a schematic cross-sectional view of the heating roller shown in FIG. 4A taken along line B-B;

FIG. 5 is a schematic view of a fixing device that is an example of a heating device according to a second exemplary embodiment;

FIG. 6 is a schematic view showing a heating roller and the like, which are a part of the fixing device shown in FIG. 5, in a partial cross section;

FIG. 7A is a schematic cross-sectional view of the heating roller shown in FIG. 6, and FIG. 7B is a schematic cross-sectional view of the heating roller shown in FIG. 7A taken along line B-B;

FIG. 8 is a schematic view of a fixing device that is an example of a heating device according to a third exemplary embodiment; and

FIG. 9A is a schematic cross-sectional view of a heating roller of a comparative example, and FIG. 9B is a schematic cross-sectional view of the heating roller shown in FIG. 9A taken along line B-B.

### DETAILED DESCRIPTION

Exemplary embodiments of the present invention will be described below.

### First Exemplary Embodiment

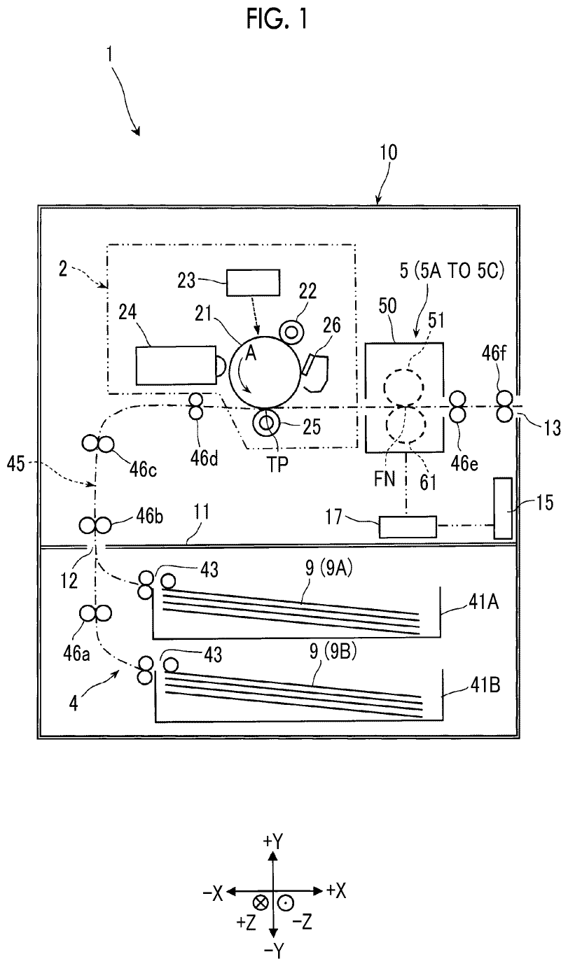

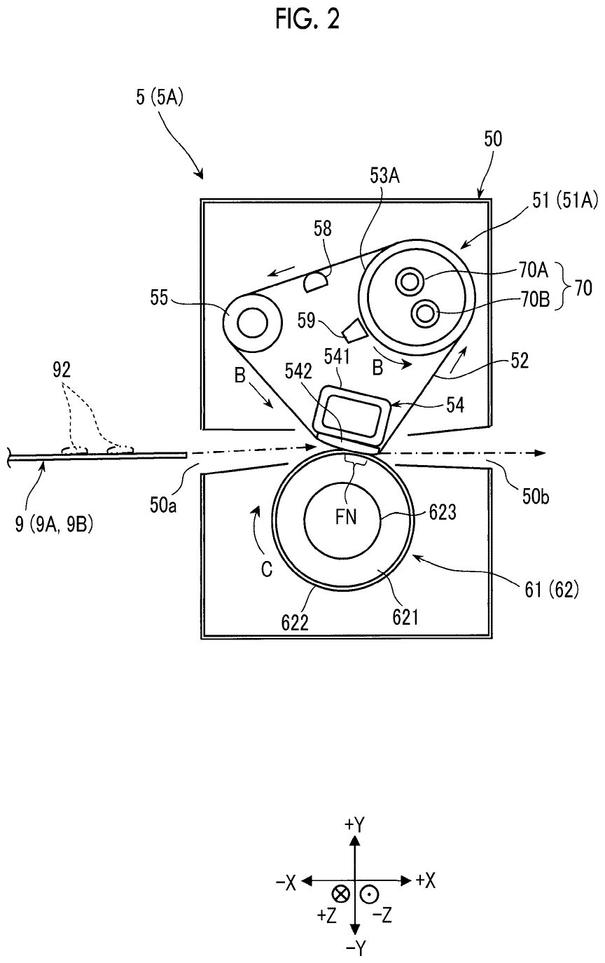

An image forming apparatus 1 including a heating device 5 according to a first exemplary embodiment is shown in FIG. 1. A fixing device 5A that is an example of the heating device 5 according to the first exemplary embodiment is shown in FIG. 2.

In the present specification and the drawings, substantially identical components will be denoted by identical reference numerals. Further, the repeated description of the identical components will be omitted in the present specification.

An arrow +X shown in FIG. 1 and the like indicates a right direction as viewed from a front side of the image forming apparatus 1 and the like, and an arrow −X indicates a left direction in that case. An arrow +Y shown in FIG. 1 and the like indicates an upward direction of the image forming apparatus 1 and the like, and an arrow −Y indicates a downward direction thereof. Reference character +Z shown in FIG. 1 and the like denotes a depth direction as viewed from the front side of the image forming apparatus 1 and the like, and reference character-Z denotes a front direction in that case.

Further, a symbol with “x” inside “∘” in FIG. 1 and the like indicates a direction from a front side to a back side of the planes of the paper of the drawings. A symbol with “⋅” inside “∘” in FIG. 1 and the like indicates a direction from the back side to the front side of the planes of the paper of the drawings.

### Image Forming Apparatus

The image forming apparatus 1 is an apparatus forming an image, which is made of a developer, on a sheet-like recording medium 9 that is an example of a member to be heated. For example, a recording paper or the like cut to a predetermined size is used as the sheet-like recording medium 9.

In the image forming apparatus 1, an image forming device 2, a medium feed device 4, a medium transport device 45, a fixing device 5A, and the like are disposed in an internal space of a housing 10. Reference numeral 15 shown in FIG. 1 denotes a control device, and reference numeral 17 denotes a power supply device.

The housing 10 is a structure that is formed in a predetermined shape. The housing 10 is divided into an upper portion and a lower portion by, for example, a partition plate 11. The partition plate 11 is provided with a medium passage port 12. Further, a part of a side surface portion of the housing 10 is provided with a medium discharge port 13.

The image forming device 2 is a device that forms a toner image made of toner used as a developer and transfers the toner image to the recording medium 9.

The image forming device 2 is configured as a device that employs an image forming method such as an electrophotographic method.

Devices, such as a charging device 22, an exposure device 23, a developing device 24, a transfer device 25, and a cleaning device 26, are disposed around a photosensitive drum 21 in the image forming device 2.

The exposure device 23 is a device that performs exposure based on image information, which is input from the outside, to form an electrostatic latent image on the photosensitive drum 21. The image information is information related to, for example, an image to be formed, such as text, figures, photographs, or patterns.

The medium feed device 4 is a device that stores and sends out recording mediums 9 to be fed to a transfer position TP of the image forming device 2.

The medium feed device 4 includes devices, such as a storage body 41 storing the recording mediums 9 and a sending device 43 that sends out the recording mediums 9 one by one. The medium feed device 4 of the first exemplary embodiment includes, for example, two storage bodies 41A and 41B. The storage bodies 41A and 41B can store, for example, recording mediums 9A and 9B having different sizes as the recording mediums 9.

The medium transport device 45 is a device that transports the recording medium 9 to a predetermined position in the housing 10. A one-dot chain line shown in FIG. 1 shows a major transport passage in a case where the recording medium 9 is transported in the housing 10 by the medium transport device 45.

The medium transport device 45 includes pairs of transport rollers 46 (46a to 46f), guide passage members (not shown), and the like.

The pairs of transport rollers 46 are pairs of transport rollers that sandwich and transport the recording medium 9. The guide passage members are members that form a transport passage or the like for guiding and transporting the recording medium 9. In the medium transport device 45, the pairs of transport rollers 46, the guide passage members, and the like are disposed at required positions in required numbers.

The fixing device 5A is a device that heats and presses an unfixed toner image transferred by the image forming device 2 to fix the toner image to the recording medium 9.

In the fixing device 5A, devices, such as a heating rotating body 51 and a pressure rotating body 61, are disposed in the internal space of a fixing housing 50.

As shown in FIG. 2, the fixing housing 50 is a structure that is provided with an introduction port 50a and a discharge port 50b for the recording medium 9. The heating rotating body 51 is a structure that is rotated while mainly exerting a heating action. The pressure rotating body 61 is a structure that is rotated while mainly exerting a pressing action.

Further, in the fixing device 5A, the heating rotating body 51 and the pressure rotating body 61 are disposed to be rotated in contact with each other. A contact portion between the heating rotating body 51 and the pressure rotating body 61 is a fixing processing portion FN that performs fixing processing of heating and pressing the toner image when the recording medium 9 and the toner image pass.

The details of the fixing device 5A will be described later.

Next, an operation for forming an image in the image forming apparatus 1 will be described.

In the image forming apparatus 1, the control device 15 receives an instruction to perform an operation for forming an image. The control device 15 is a device that controls the operation of each operation part of the image forming apparatus 1 based on input information, detection information, a control program, and the like.

At this time, in the image forming device 2, the photosensitive drum 21 starts to be rotated in a direction of an arrow A. Further, a charging operation, an exposure operation, a developing operation, a transfer operation, and a cleaning operation are executed on the rotation drum 21 in the image forming device 2. Furthermore, an operation for feeding the recording medium 9 to the transfer position TP of the image forming device 2 in cooperation with the medium transport device 45 is executed in the medium feed device 4. In addition, a state where a fixing operation can be performed is kept in the fixing device 5A.

The transfer position TP is a position where the photosensitive drum 21 and the transfer device 25 of the image forming device 2 face each other.

Accordingly, a toner image corresponding to the image information is formed on the photosensitive drum 21 in the image forming device 2. On the other hand, in the medium feed device 4, the predetermined recording medium 9 is transported to the transfer position TP via the medium transport device 45 after being sent out.

Further, the toner image is transferred from the photosensitive drum 21 to the recording medium 9 at the transfer position TP of the image forming device 2.

Subsequently, in the image forming apparatus 1, the recording medium 9 to which the toner image 92 is transferred is sent out from the transfer position TP and is transported to the fixing device 5A.

At this time, in the fixing device 5A, the recording medium 9 to which the toner image 92 is transferred is introduced into the fixing processing portion FN and passes through the fixing processing portion FN. Accordingly, the fixing operation using the fixing device 5A is executed. Further, a temperature of the fixing processing portion FN at this time is kept at a predetermined fixing temperature by a heating operation of the heating rotating body 51.

In the fixing device 5A, the toner image 92 on the recording medium 9 is heated under pressure at the fixing processing portion FN and is fixed to the recording medium 9.

In the image forming apparatus 1, the recording medium 9 subjected to fixing is discharged from the fixing device 5A and is transported up to the medium discharge port 13 by the medium transport device 45. Accordingly, the recording medium 9 subjected to fixing is sent out from the medium discharge port 13 to a medium stacking unit (not shown) and is stacked.

A basic image forming operation for forming a monochromatic image on one surface of one recording medium 9 is completed by a series of operations described above.

### Heating Device: Fixing Device

Next, the fixing device 5A, which is an example of the heating device 5, will be described in detail.

As shown in FIG. 2, a belt-nip type heating unit 51A is applied to the fixing device 5A as the heating rotating body 51. Further, a roller type pressure roller 62 is applied to the fixing device 5A as the pressure rotating body 61.

The heating unit 51A is a unit that includes a fixing belt 52, a heating roller 53A, a passage support body 54, an adjustment support roller 55, end portion connectors 56, an external heat generating element 70, and the like.

The fixing belt 52 is a belt that is in contact with a surface of the recording medium 9 to which the toner image 92 is transferred at the fixing processing portion FN to contribute to the fixing operation. The fixing belt 52 is heated by the heating roller 53A.

The fixing belt 52 is an endless cylindrical member having flexibility, heat resistance, and thermal conductivity.

A belt having a laminated structure in which an elastic layer and a release layer are formed in this order on an outer peripheral surface of a cylindrical belt substrate is applied as the fixing belt 52.

A cylindrical member made of a synthetic resin, such as polyimide or polyamide, is used as the belt substrate. A layer made of an elastic material, such as silicone rubber, is formed as the elastic layer. A layer made of a resin material, such as polytetrafluoroethylene, is formed as the release layer.

Further, the fixing belt 52 is rotatably wound around the heating roller 53A, the passage support body 54, and the adjustment support roller 55. The fixing belt 52 is rotated in a direction indicated by an arrow B in a state where the fixing belt 52 is wound.

The heating roller 53A is a roller that heats the fixing belt 52 while being rotated in contact with an inner peripheral surface of the fixing belt 52.

Further, the heating roller 53A is also a roller that indirectly heats the recording medium 9 and the toner image via the fixing belt 52.

For this reason, the fixing belt 52 is a member to be heated that is directly heated by the heating roller 53A. Further, the recording medium 9 and the toner image are members to be heated that are indirectly heated by the heating roller 53A.

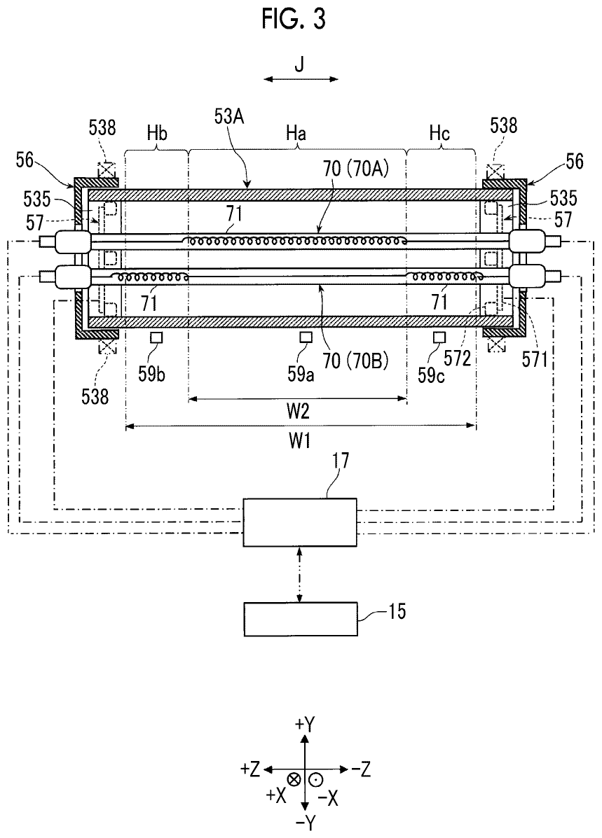

The heating roller 53A is rotatably supported by a unit frame (not shown) via bearings 538 (see FIG. 3) provided on the end portion connectors 56.

The unit frame may be a part of the fixing housing 50 or may be a body separate from the fixing housing 50.

Further, the heating roller 53A is provided with an electrically insulating layer 532 and a resistance heat generating layer 533A that are provided in this order on an inner peripheral surface of a roller substrate 531.

Furthermore, the heating roller 53A is provided with an anti-rust layer 535 on an outer peripheral surface of the roller substrate 531.

The roller substrate 531 is a cylindrical substrate made of metal on which rust may occur.

A fact that rust may occur means that the surface of metal is likely to be subjected to an oxidation-reduction reaction with oxygen, moisture, or the like in a natural environment to generate corrosion.

Iron is applied as the metal on which rust may occur, but metal such as copper can also be applied.

The roller substrate 531 is formed as a cylindrical body having a wall thickness of about 0.2 to 1.0 mm.

The electrically insulating layer 532 is a layer (film) that is made of a material having electrical insulation properties.

The electrically insulating layer 532 is formed over the entire region of the inner peripheral surface of the roller substrate 531.

In particular, the electrically insulating layer 532 is directly provided on the inner peripheral surface of the roller substrate 531 without the anti-rust layer 535.

Further, the electrically insulating layer 532 is made of a material, such as polyimide or polyether ether ketone (PEEK). The electrically insulating layer 532 is made of the above-described material as a layer having a predetermined thickness by a method, such as a spray coating method or a dip coating method.

The electrically insulating layer 532 formed on the inner peripheral surface of the roller substrate 531 is formed before rust occurs on the inner peripheral surface of the roller substrate 531.

The resistance heat generating layer 533A is a layer that generates heat by being energized. The resistance heat generating layer 533A is also referred to as an internal heat generating element since generating heat in the heating roller 53A itself.

The resistance heat generating layer 533A is formed in a region of the inner peripheral surface of the roller substrate 531 that is slightly wider than the dimension of the maximum width W1 (see FIG. 3) of the recording medium 9 during transport. The width of the recording medium 9 during transport is the dimension of a portion of the recording medium 9 along an axial direction J (see FIG. 3) of the heating roller 53A.

The resistance heat generating layer 533A is formed as one layer continuous in the axial direction J and the circumferential direction of the heating roller 53A.

Further, the resistance heat generating layer 533A is formed, for example, as a layer (film) made of a material, such as a carbon metal filler mixture, silver palladium, or gold palladium.

The resistance heat generating layer 533A is formed by a method such as a spray coating method.

In addition, the resistance heat generating layer 533A is energized via a power feed layer 534 in a case where power is fed.

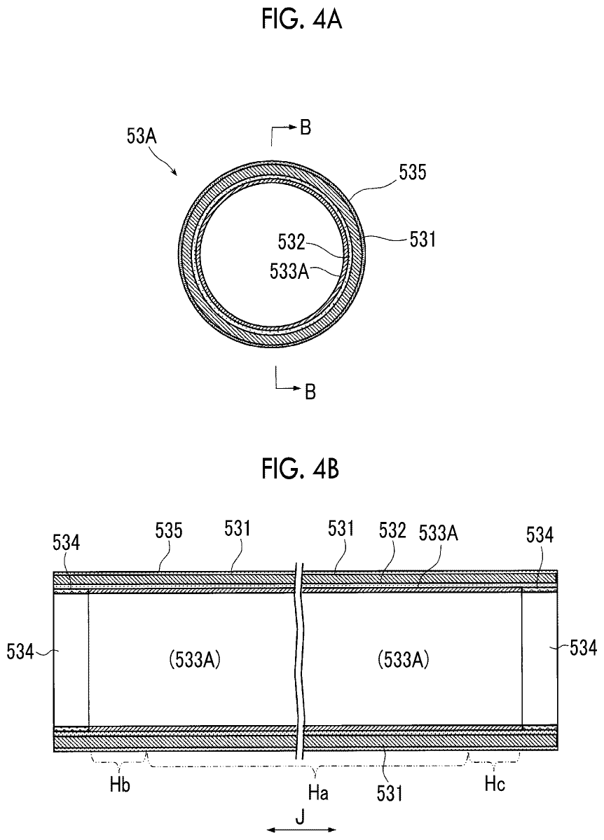

The power feed layer 534 is provided along the circumferential direction with a predetermined width on both end portions of the inner peripheral surface of the roller substrate 531 in the axial direction J (see FIG. 4B). The power feed layer 534 is formed as, for example, a layer or a film made of a material, such as beryllium copper or silver paste.

Predetermined electricity is supplied to the power feed layer 534 from contact power feeders 57 to be described later.

The anti-rust layer 535 is a treatment layer that prevents the surface of the roller substrate 531 from rusting.

The anti-rust layer 535 is provided on the outer peripheral surface of the roller substrate 531.

Strictly speaking, the anti-rust layer 535 is formed even on a portion, which will be described below, of the roller substrate 531. That is, the anti-rust layer 535 is formed even on a portion of the roller substrate 531 on which both the electrically insulating layer 532 and the resistance heat generating layer 533A are not provided. The portion on which both the electrically insulating layer 532 and the resistance heat generating layer 533A are not provided is, for example, an end face of each of both ends of the roller substrate 531. Since the anti-rust layer is formed even on such a portion, the occurrence of a defect, which is caused by the rusting of the portion of the roller substrate 531 on which both the electrically insulating layer 532 and the resistance heat generating layer 533A are not provided, is prevented.

In addition, the anti-rust layer 535 may be a layer made of a treatment agent (anti-rust agent) that prevents the occurrence of rust. A method such as a chemical conversion treatment using a treatment agent such as zinc phosphate is employed to form the anti-rust layer 535.

Here, the anti-rust layer 535 of the first exemplary embodiment does not need to be provided on the inner peripheral surface of the roller substrate 531.

For example, the following method is employed as a method of not providing the anti-rust layer 535 on the inner peripheral surface of the roller substrate 531. The method includes a method of not providing the anti-rust layer from the beginning and a method of providing the anti-rust layer on the inner peripheral surface of the roller substrate 531 and then removing the anti-rust layer. In a case where the anti-rust layer provided once is to be removed, the anti-rust layer may be removed by a method such as washing with an acidic solution.

The end portion connectors 56 are attached to and held at both end portions of the heating roller 53A.

Each of the end portion connectors 56 is formed of a short cylindrical frame in which a through-hole is formed at the center thereof. Further, the end portion connectors 56 are made of a non-conductive material.

Furthermore, both the end portions of the heating roller 53A are fitted and fixed into the internal spaces of the cylindrical frames of the end portion connectors 56. Accordingly, the end portion connectors 56 are attached to both the end portions of the heating roller 53A.

In addition, as shown in FIG. 3, the bearings 538 are disposed on the outer peripheral surfaces of the cylindrical frames of the end portion connectors 56.

Accordingly, the end portion connectors 56 are rotatably attached to the unit frame (not shown) via the bearings 538 together with the heating roller 53A.

Further, as shown in FIG. 3, the contact power feeders 57 are disposed inside both end portions of the roller substrate 531 of the heating roller 53A.

The contact power feeder 57 is a structure that is in contact with the power feed layer 534 of the heating roller 53A to feed power. Accordingly, the contact power feeders 57 feed power to the resistance heat generating layer 533A via the power feed layer 534.

For example, a structure in which a plurality of rotary terminals 572 are rotatably attached to an annular frame 571 is applied as each contact power feeder 57. The contact power feeders 57 are attached to the unit frame (not shown) or are rotatably supported by the end portion connectors 56.

In addition, as shown in FIG. 3, the contact power feeders 57 are connected to a power supply device 17. A one-dot chain line shown in FIG. 3 indicates each electric wire.

Then, when heating is required, the contact power feeders 57 are supplied with predetermined current or the like from the power supply device 17 and feed power.

The passage support body 54 is a structure that supports the fixing belt 52 to allow the fixing belt 52 to pass through the fixing processing portion FN.

The passage support body 54 includes a support body 541, a pad member 542, and the like. The support body 541 is a rectangular tubular rigid member that is disposed to extend in parallel to the axial direction J of the heating roller 53A. The pad member 542 is a soft member attached to a surface portion of the support body 541 that is in contact with the inner peripheral surface of the fixing belt 52.

Further, both end portions of the support body 541 in a longitudinal direction are attached to the unit frame (not shown), so that the passage support body 54 is fixed.

The adjustment support roller 55 is a roller that applies tension to the fixing belt 52 and supports the fixing belt 52 while adjusting the fixing belt 52 to stabilize a state where the fixing belt 52 rotates and travels. The adjustment support roller 55 is also called a steering roller that is displaced to suppress the occurrence of meandering of the fixing belt 52.

The adjustment support roller 55 is rotatably and displaceably attached to the unit frame (not shown) to support the fixing belt 52 in contact with the inner peripheral surface of the fixing belt 52. Further, shaft portions of the adjustment support roller 55 are biased in a predetermined direction by a biasing member such as a spring (not shown).

Next, the external heat generating element 70 is a heat generating element that is disposed in an internal space of the roller substrate 531 and generates heat by itself to heat the heating roller 53A. The external heat generating element 70 is called an external heat generating element since being a heat generating element separate from the heating roller 53A.

As shown in FIG. 3, the external heat generating element 70 of the first exemplary embodiment includes a first external heat generating element 70A and a second external heat generating element 70B. Further, for example, a halogen lamp (heater) is used as the external heat generating element 70.

The first external heat generating element 70A and the second external heat generating element 70B are divided such that heat generating portions 71 thereof are different from each other in the axial direction J of the heating roller 53A.

That is, the heat generating portion 71 of the first external heat generating element 70A is disposed in a middle portion Ha that is a middle region in the axial direction J. Further, the heat generating portions 71 of the second external heat generating element 70B are disposed at end portions Hb and Hc that are regions present outside both ends of the middle portion Ha.

The middle portion Ha is a zone having a width that is set based on a width W2 of a small size group in which a width W of a recording medium 9 during transport is relatively small. Specifically, the width W2 is the maximum width in the small size group.

The end portions Hb and Hc are zones that remain on both sides in a case where the middle portion Ha is excluded from the maximum width W1 of the recording medium 9 during transport. Further, the end portions Hb and Hc are also zones having widths that are set based on a width W1 of a large size group in which a width W of a recording medium 9 is relatively large. The width W1 is the maximum width in the large size group. The width of the recording medium 9 included in the large size group is a width larger than the width W2 and equal to or smaller than the width W1.

Incidentally, the middle portion Ha and the end portions Hb and Hc at this time are present at positions that are set in a case where transport using a center registration method is performed. The center registration method is a method in a case where a recording medium 9 is transported such that a middle of the width W of the recording medium 9 is moved along a middle of the width of the transport passage.

Both end portions of each of the first external heat generating element 70A and the second external heat generating element 70B are attached to the unit frame (not shown) or the like.

Further, the first external heat generating element 70A and the second external heat generating element 70B are individually connected to the power supply device 17 as shown in FIG. 3. For this reason, a heat generation operation of one or both of the first external heat generating element 70A and the second external heat generating element 70B can be performed depending on the presence or absence (switching) of energization. Furthermore, the switching of the energization of the first external heat generating element 70A and the second external heat generating element 70B is controlled by the control device 15.

In addition, as shown in FIG. 2, a lubricant application device 58 and a temperature sensor 59 are disposed in the heating unit 51A.

The lubricant application device 58 is a device that applies a lubricant to the inner peripheral surface of the fixing belt 52. The temperature sensor 59 is a sensor that measures a surface temperature of the heating roller 53A.

Of the lubricant application device 58 and the temperature sensor 59, as the temperature sensor 59, a plurality of temperature sensors 59a to 59c are disposed at three positions in the axial direction J of the heating roller 53A (see FIG. 3).

Further, in the heating unit 51A, detection (measurement) information obtained by the temperature sensors 59a to 59c is transmitted to the control device 15. Meanwhile, the control device 15 controls a power feed operation of the power supply device 17 according to the detection information.

Accordingly, in the heating unit 51A, the heating state of the heating roller 53A is adjusted while the surface temperature of the heating roller 53A is detected.

Next, the pressure roller 62 is a roller having a structure in which an elastic release layer 622 is provided on an outer peripheral surface of a roller substrate 621 as shown in FIG. 2. Reference numeral 623 shown in FIG. 2 and the like denotes a shaft portion.

The roller substrate 621 has a shape that includes a columnar or cylindrical body portion and shaft portions provided at both end portions of the body portion.

The pressure roller 62 is supported by a pressure support mechanism (not shown) that is disposed in the fixing housing 50.

The pressure support mechanism supports the shaft portions 623 of the pressure roller 62 via bearings such that the shaft portions 623 are rotatable.

The pressure support mechanism supports the shaft portions 623 of the pressure roller 62 such that the body portion of the pressure roller 62 is in pressure contact with the fixing belt 52 at the fixing processing portion FN. In the pressure support mechanism, the shaft portions 623 of the pressure roller 62 are biased with a predetermined pressure by a biasing member such as a spring.

Accordingly, the pressure roller 62 presses the fixing belt 52, which passes through the fixing processing portion FN, against the passage support body 54 with a predetermined pressure.

The pressure support mechanism can also move the pressure roller 62 to a position away from the fixing processing portion FN (the passage support body 54).

Further, a passive gear (not shown) is disposed at least at one end portion of the pressure roller 62. Furthermore, the passive gear meshes with a transmission gear that transmits rotational power generated from a rotation drive device (not shown).

Accordingly, when the pressure roller 62 is to be operated, the passive gear receives rotational power and is rotationally driven in a direction of an arrow C.

### Heating Operation or Fixing Operation

The fixing device 5A operates as follows.

In a case where a major power supply of the image forming apparatus 1 is turned on, the heating roller 53A of the heating unit 51A is heated in the fixing device 5A. Further, the pressure roller 62 starts to rotate in the fixing device 5A.

At this time, the pressure roller 62 receives rotational power from the rotation drive device (not shown) and starts to be rotationally driven in the direction of the arrow C.

Accordingly, in the fixing device 5A, the fixing belt 52 receives rotational power from the pressure roller 62 at the fixing processing portion FN and is driven to rotate in a direction of an arrow B.

Further, at this time, power is fed to the resistance heat generating layer 533A and the external heat generating element 70 of the heating roller 53A from the power supply device 17.

Power is fed to the resistance heat generating layer 533A from the power supply device 17 via the contact power feeders 57 and the power feed layer. Furthermore, power is fed to each of the first external heat generating element 70A and the second external heat generating element 70B of the external heat generating element 70 from the power supply device 17.

Accordingly, in the fixing device 5A, the roller substrate 531 of the heating roller 53A is heated by heat generated from the resistance heat generating layer 533A and heat generated from the external heat generating element 70. Further, in the fixing device 5A, the fixing belt 52 is kept in a state where the fixing belt 52 is heated to a predetermined fixing temperature by the heating roller 53A.

In the fixing device 5A at this time, the heating roller 53A includes the roller substrate 531 made of iron and is heated by both the resistance heat generating layer 533A and the external heat generating element 70.

For this reason, the warm-up time of the heating roller 53A and, by extension, the fixing belt 52 can be shortened in the fixing device 5A.

In a case where the fixing belt 52 is heated to a predetermined fixing temperature, the fixing device 5A is in a state where a fixing operation can be performed.

Further, in a case where an image forming operation is executed, a heat generation operation of the external heat generating element 70 is controlled in the fixing device 5A according to the width W of the recording medium 9.

Furthermore, at this time, the heat generation operation of the resistance heat generating layer 533A is stopped in the fixing device 5A.

That is, in a case where a recording medium 9A having a width included in the large size group is used as the recording medium 9, both the first external heat generating element 70A and the second external heat generating element 70B of the external heat generating element 70 generate heat.

Accordingly, the heating roller 53A and, by extension, the fixing belt 52 are heated at all of the middle portion Ha and the end portions Hb and Hc.

As a result, the recording medium 9A having a width included in the large size group is sufficiently heated in the axial direction J at the fixing processing portion FN.

On the other hand, in a case where a recording medium 9B having a width included in the small size group is used as the recording medium 9, the first external heat generating element 70A of the external heat generating element 70 performs a heat generation operation. That is, in this case, the second external heat generating element 70B does not perform a heat generation operation.

Accordingly, the heating roller 53A and, by extension, the fixing belt 52 are heated at only the middle portion Ha.

As a result, the recording medium 9B having a width included in the small size group is sufficiently heated in the axial direction J at the fixing processing portion FN. At the same time, a portion (non-passage portion) through which the recording medium 9B does not pass is not heated at the fixing processing portion FN. The non-passage portion corresponds to the end portions Hb and Hc.

For this reason, the end portions Hb and Hc of the fixing processing portion FN or the heating roller 53A do not absorb heat from the recording medium 9B, so that an abnormal temperature rise at the end portions Hb and Hc is avoided.

In a Case where a Rapid Temperature Change Occurs

For example, in a case where a fixing operation using the recording medium 9B having a width included in the small size group is continuously performed, the following occurs in the fixing device 5A.

In this case, a rapid temperature change occurs between the middle portion Ha and the end portions Hb and Hc of the heating roller 53A in the fixing device 5A.

It is considered that the rapid temperature change at this time is caused by the following factors.

That is, the middle portion Ha of the heating roller 53A tends to be heated by the first external heat generating element 70A, to continuously accumulate heat, and to increase in temperature. On the other hand, the end portions Hb and Hc of the heating roller 53A continue to be in a state where the end portions Hb and Hc are not heated by the second external heat generating element 70B. As a result, a temperature difference between the middle portion Ha and the end portions Hb and Hc gradually increases.

Even though a rapid temperature change occurs between the middle portion Ha and the end portions Hb and Hc of the heating roller 53A as described above, the following results are obtained in the fixing device 5A.

That is, a part of the resistance heat generating layer 533A or the electrically insulating layer 532, which is provided on the inner peripheral surface, at a portion of the heating roller 53A where a rapid temperature rise has occurred is not peeled off from the roller substrate 531.

For this reason, the occurrence of heating failure or fixing failure of the heating roller 53A or the like caused by the peeling of the resistance heat generating layer 533A or the like is prevented in the fixing device 5A.

As a result, the occurrence of poor image quality caused by the above-described fixing failure of the fixing device 5A is also prevented in the image forming apparatus 1.

### Comparative Example and Reference Example

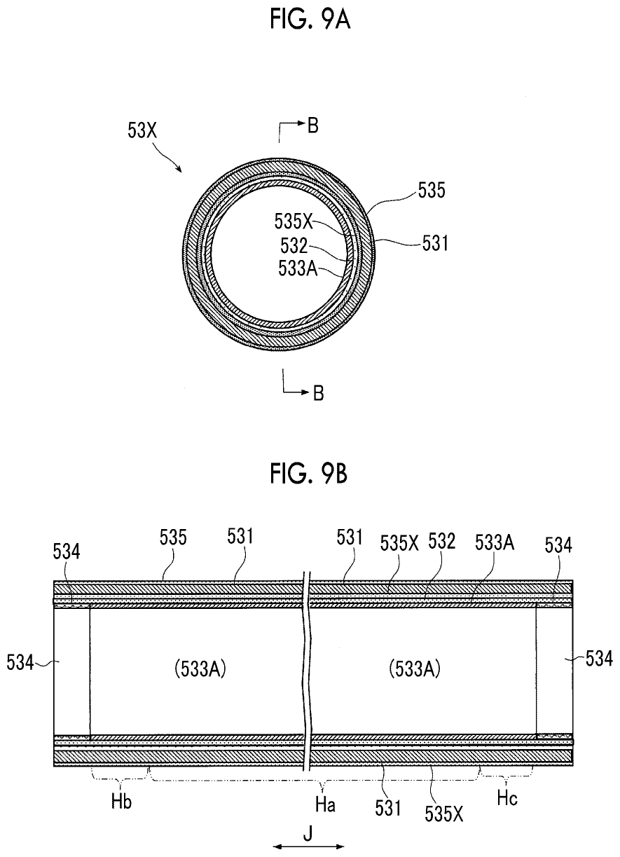

However, in a case where the fixing device 5A employs a heating roller 53X of a comparative example illustrated in FIGS. 9A and 9B instead of the heating roller 53A, the following defect occurs.

In the heating roller 53X of the comparative example, an anti-rust layer 535X is provided on the inner peripheral surface of the roller substrate 531 and then the electrically insulating layer 532 and the resistance heat generating layer 533A are provided. The heating roller 53X has a configuration identical to the configuration of the heating roller 53A except that the anti-rust layer 535X is provided.

In a case where a rapid temperature change occurs between the middle portion Ha and the end portions Hb and Hc of the heating roller 53X described above, the following peeling has occurred in the fixing device 5A to which the heating roller 53X of the comparative example is applied.

In the fixing device 5A in this case, a part of the resistance heat generating layer 533A or the electrically insulating layer 532, which is provided on the inner peripheral surface, at a portion of the heating roller 53X where a rapid temperature rise has occurred is peeled off from the roller substrate 531. It is presumed that the peeling is caused by a difference in a thermal expansion coefficient between the anti-rust layer 535X and the electrically insulating layer 532 or the resistance heat generating layer 533A.

For this reason, the heating failure or fixing failure of the heating roller 53X or the like caused by the peeling also occurs in the fixing device 5A in this case.

Further, the inventors of the present invention have performed evaluation tests in a case where a heating roller 53X′ of a reference example is applied instead of the heating roller 53X of the comparative example.

The heating roller 53X′ of the reference example is a heating roller that is formed in a case where the anti-rust layer 535X is changed into an anti-rust agent having high heat resistance. The anti-rust layer 535X of the heating roller 53X′ of the reference example is formed such that an anti-rust treatment agent such as zinc phosphate is changed to have improved heat resistance.

In a case where a rapid temperature change occurs between the middle portion Ha and the end portions Hb and Hc of the heating roller 53X′ described above, the following peeling has occurred in the fixing device 5A to which the heating roller 53X′ of the reference example is applied.

In the fixing device 5A in this case, a part of the resistance heat generating layer 533A or the electrically insulating layer 532, which is provided on the inner peripheral surface, at a portion of the heating roller 53X′ where a rapid temperature rise has occurred is slightly peeled off. The degree of peeling in this case is less than the degree of peeling in a case where the heating roller 53X of the comparative example is applied.

However, it has been confirmed that the occurrence of peeling cannot be prevented even in a case where the heating roller 53X′ of the reference example is applied.

In this regard, in the fixing device 5A according to the first exemplary embodiment, the peeling of the resistance heat generating layer 533A or the like does not occur even in a case where a rapid temperature change occurs between the middle portion Ha and the end portions Hb and Hc of the heating roller 53A.

Further, in the fixing device 5A, the peeling of the resistance heat generating layer 533A or the like can be prevented without the addition of a new member such as the insertion of a metal foil pipe described in JP2001-134124A (claim 1, Paragraph 0006, and FIG. 1).

### Additional Configuration

In the fixing device 5A according to the first exemplary embodiment, the resistance heat generating layer 533A may be caused to temporarily generate heat on the way in a case where the rapid temperature change described above is likely to occur.

Further, the second external heat generating element 70B of the external heat generating element 70 may be caused to temporarily generate heat on the way in a case where the rapid temperature change described above is likely to occur.

For example, a case where a continuous fixing operation using heat generated from only the first external heat generating element 70A has been performed until the number of recording mediums 9B having passed reaches a predetermined number of recording mediums may be assumed as a case where the rapid temperature change described above is likely to occur.

Further, the temporary generation of heat described above may be the generation of heat that is long enough to suppress the rapid temperature change described above. For example, the temporary generation of heat described above is to generate heat only while (during a period of time in which) a predetermined number of recording mediums 9B pass through.

### Second Exemplary Embodiment

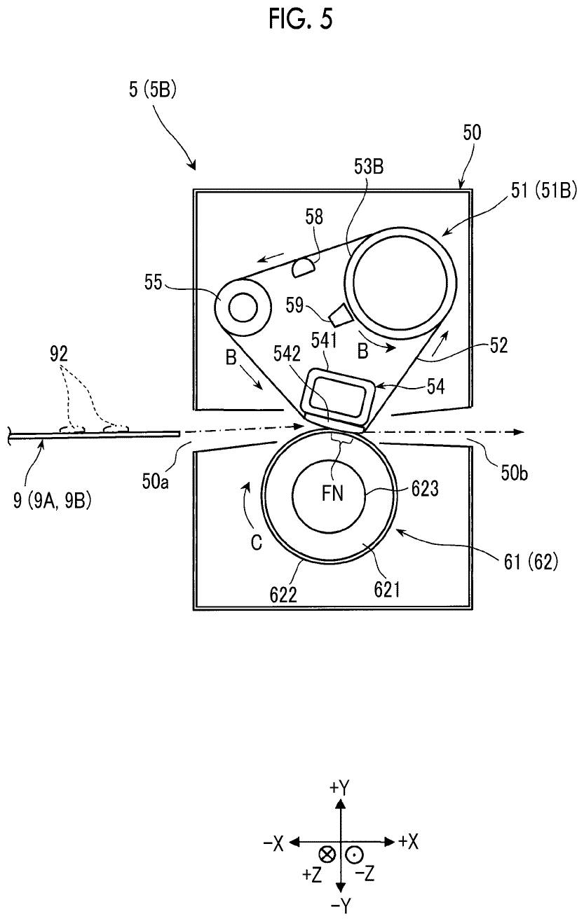

A fixing device 5B according to a second exemplary embodiment of the present invention is shown in FIG. 5.

In a case where the fixing device 5B is compared with the fixing device 5A (see FIG. 2 and the like) according to the first exemplary embodiment, the heating unit 51A is changed to a heating unit 51B to which a heating roller 53B is applied instead of the heating roller 53A. The other configurations are identical to the configurations described above.

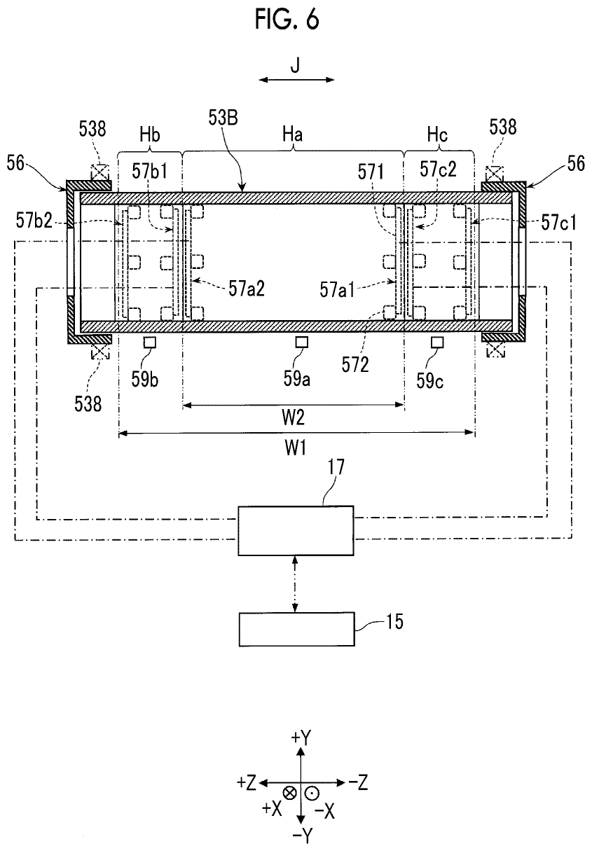

The heating roller 53B is different from the heating roller 53A of the first exemplary embodiment in that the external heat generating element 70 is not employed and a resistance heat generating layer 533B is employed (see FIGS. 5 and 6).

The resistance heat generating layer 533B of the heating roller 53B is provided in a pattern in which a heat generating region is divided to be different in an axial direction J of the heating roller 53B.

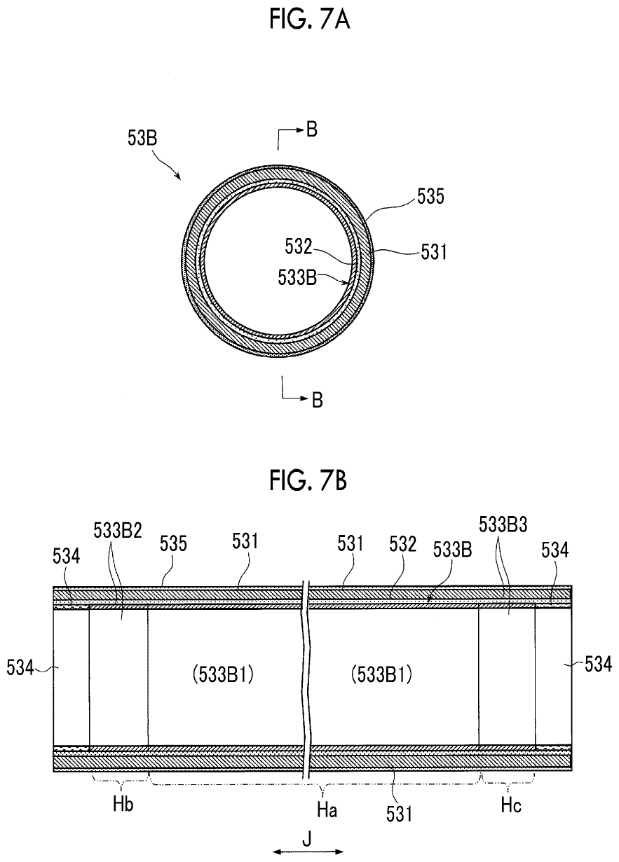

That is, as shown in FIG. 7B, the resistance heat generating layer 533B is divided into a first resistance heat generating layer 533B1, a second resistance heat generating layer 533B2, and a third resistance heat generating layer 533B3.

The first resistance heat generating layer 533B1 is a resistance heat generating layer portion that is heated at a middle portion Ha in the axial direction J. The second resistance heat generating layer 533B2 and the third resistance heat generating layer 533B3 are resistance heat generating layer portions that are heated at end portions Hb and Hc in the axial direction J, respectively.

The middle portion Ha and the end portions Hb and Hc are zones that are divided based on criteria identical to the middle portion Ha and the end portions Hb and Hc described in the first exemplary embodiment.

The first resistance heat generating layer 533B1, the second resistance heat generating layer 533B2, and the third resistance heat generating layer 533B3 are made of a material identical to the material of the resistance heat generating layer 533A of the first exemplary embodiment.

Further, a boundary portion between the first resistance heat generating layer 533B1 and the second resistance heat generating layer 533B2 and a boundary portion between the first resistance heat generating layer 533B1 and the third resistance heat generating layer 533B3 are formed as follows. That is, the boundary portion is formed as a portion where any layer of the resistance heat generating layers is not provided, a portion where an electrically insulating layer is provided, or the like.

As shown in FIG. 6, power is fed to the resistance heat generating layer 533B by three sets of contact power feeders 57a, 57b, and 57c.

The contact power feeder 57a is in contact with both end portions of the first resistance heat generating layer 533B1 via a pair of contact power feeders 57al and 57a2 to feed power. The contact power feeder 57b is in contact with both end portions of the second resistance heat generating layer 533B2 via a pair of contact power feeders 57b1 and 57b2 to feed power.

The contact power feeder 57c is in contact with both end portions of the third resistance heat generating layer 533B3 via a pair of contact power feeders 57cl and 57c2 to feed power.

The three sets of contact power feeders 57a, 57b, and 57c are attached to a unit frame (not shown) or the like.

Further, the three sets of contact power feeders 57a, 57b, and 57c are connected to the power supply device 17 as shown in FIG. 6. A one-dot chain line shown in FIG. 6 indicates each electric wire.

Then, when heating is required, the contact power feeders 57a, 57b, and 57c are supplied with a predetermined current or the like from the power supply device 17 and feed power.

For this reason, heat generation operations of a part or all of the first resistance heat generating layer 533B1, the second resistance heat generating layer 533B2, and the third resistance heat generating layer 533B3 can be performed depending on the switching of the presence or absence of energization. Further, the switching of the energization of the first resistance heat generating layer 533B1, the second resistance heat generating layer 533B2, and the third resistance heat generating layer 533B3 is controlled by the control device 15.

### Heating Operation/Fixing Operation

In a case where an image forming operation is executed, a heat generation operation of the resistance heat generating layer 533B is controlled in the fixing device 5B according to a width W of a recording medium 9.

That is, in a case where a recording medium 9A having a width included in the large size group is used as the recording medium 9, the following heat generation operation is performed.

In this case, the heat generation operations of all of the first resistance heat generating layer 533B1, the second resistance heat generating layer 533B2, and the third resistance heat generating layer 533B3 are performed.

Further, in a case where a recording medium 9B having a width included in the small size group is used as the recording medium 9, the following heat generation operation is performed.

In this case, only the heat generation operation of the first resistance heat generating layer 533B1 is performed. Furthermore, in this case, the heat generation operations of the second resistance heat generating layer 533B2 and the third resistance heat generating layer 533B3 are not performed.

Incidentally, a temperature distribution in the axial direction J during heating can be adjusted in the heating roller 53B without using the external heat generating element 70 of the first exemplary embodiment together.

For example, in a case where a fixing operation using the recording medium 9B having a width included in the small size group is continuously performed, the following occurs in the fixing device 5B.

In the fixing device 5B in this case, a rapid temperature change occurs between the middle portion Ha and the end portions Hb and Hc of the heating roller 53B.

It is considered that the rapid temperature change at this time is caused by the following factors.

That is, the middle portion Ha of the heating roller 53B tends to be heated by the first resistance heat generating layer 533B1, to continuously accumulate heat, and to increase in temperature. On the other hand, the end portions Hb and Hc of the heating roller 53B continue to be in a state where the end portions Hb and Hc are not heated by the second resistance heat generating layer 533B2 and the third resistance heat generating layer 533B3.

As a result, a temperature difference between the middle portion Ha and the end portions Hb and Hc gradually increases.

Even though a rapid temperature change occurs between the middle portion Ha and the end portions Hb and Hc of the heating roller 53B as described above, the following results are obtained in the fixing device 5B.

That is, a part of the resistance heat generating layer 533B or the electrically insulating layer 532, which is provided on the inner peripheral surface, at a portion of the heating roller 53B where a rapid temperature rise has occurred is not peeled off from the roller substrate 531.

For this reason, the occurrence of heating failure or fixing failure of the heating roller 53B or the like caused by the peeling of the resistance heat generating layer 533B or the like is prevented even in the fixing device 5B.

As a result, the occurrence of poor image quality caused by the above-described fixing failure of the fixing device 5B is also prevented in the image forming apparatus 1.

### Additional Configuration

In the fixing device 5B, the second resistance heat generating layer 533B2 and the third resistance heat generating layer 533B3 in addition to the first resistance heat generating layer 533B1 may be caused to temporarily generate heat on the way in a case where the rapid temperature change described above is likely to occur.

### Third Exemplary Embodiment

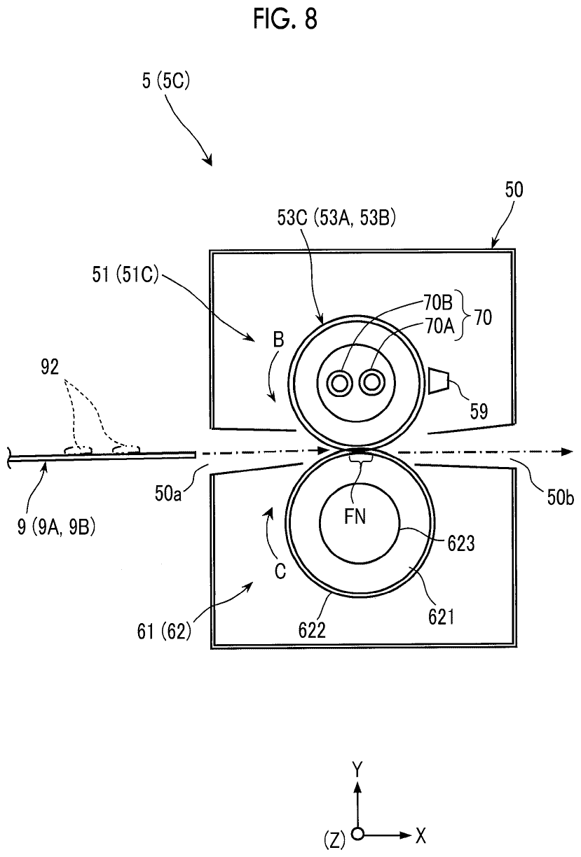

A fixing device 5C according to a third exemplary embodiment of the present invention is shown in FIG. 8.

In a case where the fixing device 5C is compared with the fixing device 5A (see FIG. 2 and the like) according to the first exemplary embodiment, the heating unit 51A is changed to a heating unit 51C as the heating rotating body 51. The other configurations are identical to the configurations described above.

The heating unit 51C is not a belt-nip type heating unit but a roller type heating unit using a heating roller 53C.

The heating unit 51C includes a heating roller 53C, an external heat generating element 70, and the like.

In this case, the heating roller 53C is a roller that directly heats a recording medium 9 and a toner image.

The heating roller 53C has a configuration substantially identical to the configuration of the heating roller 53A of the first exemplary embodiment, except that some factors, such as the outer diameter of the roller, are different.

The heating roller 53C includes end portion connectors 56 (see FIG. 3) as in the heating roller 53A of the first exemplary embodiment.

Further, the external heat generating element 70 of the heating roller 53C includes a first external heat generating element 70A and a second external heat generating element 70B as in the external heat generating element 70 of the first exemplary embodiment.

Furthermore, the heating roller 53C is rotationally driven in a direction of an arrow B.

In the fixing device 5C, a portion where the heating roller 53C and the pressure roller 62 are in contact with each other is a fixing processing portion FN.

In the fixing device 5C, a recording medium 9 to which a toner image 92 is transferred is introduced into the fixing processing portion FN and passes through the fixing processing portion FN, so that a fixing operation is performed.

The fixing device 5C operates in a manner substantially identical to the fixing device 5A according to the first exemplary embodiment.

For example, in a case where a fixing operation using a recording medium 9B having a width included in the small size group is continuously performed, the following occurs even in the fixing device 5C.

In this case, a rapid temperature change occurs between the middle portion Ha and the end portions Hb and Hc (see FIG. 3) of the heating roller 53C.

Even in a case where the rapid temperature change described above occurs in the heating roller 53C, the following peeling does not occur in the fixing device 5C.

That is, a part of the resistance heat generating layer 533A or the electrically insulating layer 532 (see FIG. 4), which is provided on the inner peripheral surface, at a portion of the heating roller 53C where a rapid temperature rise has occurred is not peeled off from the roller substrate 531.

For this reason, the occurrence of heating failure or fixing failure of the heating roller 53C or the like caused by the peeling of the resistance heat generating layer 533A or the like is prevented even in the fixing device 5C.

As a result, the occurrence of poor image quality caused by the above-described fixing failure of the fixing device 5C is also prevented in the image forming apparatus 1.

### Modification Example of Third Exemplary Embodiment

In the fixing device 5C, the heating roller 53B of the second exemplary embodiment may be applied to the heating unit 51C instead of the heating roller 53C.

The heating roller 53B of this modification example is different from the heating roller 53A of the first exemplary embodiment in terms of the following. That is, in the heating roller 53B of the modification example, the external heat generating element 70 is not employed and the resistance heat generating layer 533B is employed.

### Modification Examples

The present invention is not limited to the configuration example illustrated in each of the above-described exemplary embodiments. That is, the present invention can be modified as long as the scope of the invention described as a solution to the problem is not changed.

For this reason, the present invention also includes modification examples to be described below, for example.

The heating device 5 according to the exemplary embodiment of the present invention may be, for example, a device that heats a member to be heated which requires heating and drying.

The heating device 5 in this case heats a member to be heated, which requires heating and drying, by transporting the member to be heated such that the member is in direct or indirect contact with a heating roller. The member to be heated at this time may be a member that can be dried in direct or indirect contact with the heating roller.

The resistance heat generating layers 533A and 533B and the like of the heating roller of the heating device 5 may be provided on the outer peripheral surface of the roller substrate 531.

Further, the resistance heat generating layers 533A and 533B may be provided on both the inner peripheral surface and the outer peripheral surface of the roller substrate 531. In a case where the resistance heat generating layers 533A and 533B are provided on both the inner peripheral surface and the outer peripheral surface of the roller substrate 531, an anti-rust layer is not present on both the inner peripheral surface and the outer peripheral surface.

Furthermore, the heating roller of the heating device 5 may be provided with a layer other than the anti-rust layer 535 on the inner peripheral surface or the outer peripheral surface of the roller substrate 531 on which the resistance heat generating layers 533A and 533B are provided.

In addition, the resistance heat generating layer 533B or the external heat generating element 70 of the heating device 5 may be configured in a pattern in which a region or a portion to be heated is divided into a number other than three.

Further, the configuration of a rotation drive system for the heating rotating body 51 and the pressure rotating body 61 of the heating device 5 may be a configuration other than the configuration exemplified in the first exemplary embodiment.

In the first exemplary embodiment and the like, the image forming apparatus 1 for forming a monochromatic image has been exemplified as the image forming apparatus 1.

However, in a case where a fixing device including the heating device 5 is required, the image forming apparatus 1 according to the exemplary embodiment of the present invention may be another type of image forming apparatus. For example, the image forming apparatus 1 according to the exemplary embodiment of the present invention may be an apparatus that uses an intermediate transfer method or the like to form a multicolor image in which a plurality of colors of toners are combined.

### Supplementary Note

(((1)))

A heating device comprising:
a heating roller that is rotated to heat a member to be heated,
wherein the heating roller is provided with at least an electrically insulating layer and a resistance heat generating layer that are provided in this order on one or both of an inner peripheral surface and an outer peripheral surface of a cylindrical roller substrate made of metal on which rust occurs, without an anti-rust layer.
   (((2)))

The heating device according to (((1))),
wherein the resistance heat generating layer is provided in a divided pattern in which a heat generating region is divided to be different in an axial direction of the heating roller.
   (((3)))

The heating device according to (((2))),
wherein the divided pattern is a pattern that is divided to correspond to a difference in a width of the member to be heated in the axial direction of the heating roller.
   (((4)))

The heating device according to (((1))),
wherein a heat generating element having a divided structure in which a heat generating portion is divided to be different in the axial direction of the heating roller is disposed in an internal space of the roller substrate.
   (((5)))

The heating device according to (((4))),
wherein the resistance heat generating layer is provided as one layer continuous in the axial direction and a circumferential direction of the heating roller.
   (((6)))

The heating device according to (((1))),
wherein an anti-rust layer is provided on a portion of the roller substrate on which the electrically insulating layer and the resistance heat generating layer are not provided.
   (((7)))

An image forming apparatus comprising:
a fixing device that includes the heating device according to any one of (((1))) to (((6))).
   (((8)))

The image forming apparatus according to (((7))),
wherein the fixing device is a fixing device using a fixing belt that is stretched around a plurality of rollers including the heating roller and is rotated, and
the heating roller is a heating roller of the heating device.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A heating device comprising:
a heating roller that is rotated to heat a member to be heated,
wherein the heating roller is provided with at least an electrically insulating layer and a resistance heat generating layer that are provided in this order on one or both of an inner peripheral surface and an outer peripheral surface of a cylindrical roller substrate made of metal on which rust occurs, without an anti-rust layer.

2. The heating device according to claim 1,
wherein the resistance heat generating layer is provided in a divided pattern in which a heat generating region is divided to be different in an axial direction of the heating roller.

3. The heating device according to claim 2,
wherein the divided pattern is a pattern that is divided to correspond to a difference in a width of the member to be heated in the axial direction of the heating roller.

4. The heating device according to claim 1,
wherein a heat generating element having a divided structure in which a heat generating portion is divided to be different in the axial direction of the heating roller is disposed in an internal space of the roller substrate.

5. The heating device according to claim 4,
wherein the resistance heat generating layer is provided as one layer continuous in the axial direction and a circumferential direction of the heating roller.

6. The heating device according to claim 1,
wherein an anti-rust layer is provided on a portion of the roller substrate on which the electrically insulating layer and the resistance heat generating layer are not provided.

7. An image forming apparatus comprising:
a fixing device that includes the heating device according to claim 1.

8. An image forming apparatus comprising:
a fixing device that includes the heating device according to claim 2.

9. An image forming apparatus comprising:
a fixing device that includes the heating device according to claim 3.

10. An image forming apparatus comprising:
a fixing device that includes the heating device according to claim 4.

11. An image forming apparatus comprising:
a fixing device that includes the heating device according to claim 5.

12. An image forming apparatus comprising:
a fixing device that includes the heating device according to claim 6.

13. The image forming apparatus according to claim 7,
wherein the fixing device is a fixing device using a fixing belt that is stretched around a plurality of rollers including the heating roller and is rotated, and
the heating roller is a heating roller of the heating device.

14. The image forming apparatus according to claim 8,
wherein the fixing device is a fixing device using a fixing belt that is stretched around a plurality of rollers including the heating roller and is rotated, and
the heating roller is a heating roller of the heating device.

15. The image forming apparatus according to claim 9,
wherein the fixing device is a fixing device using a fixing belt that is stretched around a plurality of rollers including the heating roller and is rotated, and
the heating roller is a heating roller of the heating device.

16. The image forming apparatus according to claim 10,
wherein the fixing device is a fixing device using a fixing belt that is stretched around a plurality of rollers including the heating roller and is rotated, and
the heating roller is a heating roller of the heating device.

17. The image forming apparatus according to claim 11,
wherein the fixing device is a fixing device using a fixing belt that is stretched around a plurality of rollers including the heating roller and is rotated, and
the heating roller is a heating roller of the heating device.

18. The image forming apparatus according to claim 12,
wherein the fixing device is a fixing device using a fixing belt that is stretched around a plurality of rollers including the heating roller and is rotated, and
the heating roller is a heating roller of the heating device.
